(19) United States
(12) Patent Application Publication
(10) Pub. No.: US 2008/0046327 A1
(43) Pub. Date: Feb. 21, 2008

(54) Online Shop Interface Providing Fully Featured Websites Individualized And Published During A Simple Order Process

(76) Inventor: Cornel Schnietz, Cologne (DE)

Correspondence Address: CONTENT MANAGEMENT AG, IM MEDIAPARK 6, COLOGNE, D-50670, omitted

(21) Appl. No.: 11/464,526

(22) Filed: Aug. 15, 2006

(51) Int. Cl. G06Q 30/00

(52) U.S. Cl. 705/26

(57) ABSTRACT

Without using online or offline software at any stage, homepageNOW provides recognizably complete websites to customers through its online shop interface. Previously, obtaining a website involved commissioning a website design company, using online or offline software, purchasing templates or writing the code in a word processing editor. Dependent upon which of the above processes was used, domain registration and hosting space arrangements were also required. homepageNOW is a new way of obtaining a website as it does not deploy any of the processes mentioned above. homepageNOW is an online shop interface that dispenses websites from stock and during the ordering process, personal information about the customer is collected in form fields and is then superimposed onto the website to individualize it. A homepageNOW website contains pre-written web page content for each category of website offered. Previously, customers had to write content themselves or commission writers to provide it for them.

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### FIELD OF THE INVENTION

The invention relates to the provision of websites via an online shop interface. More specifically, websites which are selected from stock by customers then individualized and published publicly on the Internet during a simple order process.

### BACKGROUND OF THE INVENTION

Without using online or offline software at any stage, homepageNOW delivers personalized and recognizably complete websites to customers via an order process in an online shop interface. No programming is involved as the individualization and automatic publishing of each website take place during the order.

Before this invention, we can list the ways available to customers to create and publish a website using the traditional methods of—software, commissioning a design agency or writing HTML code and content in an editor. We define software to include applications installed on a user's local computer (offline) and tools intended to run inside a user's browser (online).

An example of software (offline) in operation—Microsoft FrontPage: Buy and install website creation software on a local computer and if necessary purchase web page templates or design a website using graphical software. Use an HTML editor to enter and edit contents. Configure/create extra settings like photo album, guestbook, contact form, blog, etc. Upload the results to directories and publish on purchased or leased web space reserved to a domain which has been arranged and cleared by a service provider or domain registration agency beforehand. The website is available on the Internet.

An example of software (online) in operation—Verio WebsiteCreator: Open the online software in the browser. Step through the wizard for the website creation. Select a design template. Define pages for the website. Add and edit the page contents including text, headlines and sub-headlines. Define extra settings like photo album, guestbook, contact form, blog, etc. Save the project online. Publish the results on purchased or leased web space reserved to a domain which has been arranged and cleared by a service provider or domain registration agency beforehand. The website is available on the Internet.

An example of commissioning a design agency. A user selects a website design agency and arranges a consultation either by phone, email or in person. During the consultation, requirements will be discussed, pricing highlighted and at the end of the first phase of the meetings, the design agency will usually offer to arrange the registration of a domain or to transfer an existing domain to reserved web space. Designers will then follow the design brief which was agreed and at this stage, the user will write text and content for the website before sending it to the design agency for incorporation within the website. A stage of proofing and checks will lead to publishing on the web design agency's servers and the website will be live on the Internet.

An example of manually making a website: A user writes or copies and pastes HTML code and text content in editing software such as Microsoft WordPad and saves the file before uploading the page to directories which are part of the web space which has been pre-arranged, leased or purchased from a service provider. The space may have already been assigned to a domain which was registered or this will be done after the code and content has been written. Graphics and images will usually also be uploaded to the directories within the web space before the website is published on the Internet.

### BRIEF SUMMARY OF THE INVENTION

homepageNOW is a Web 2.0 way to acquire a website which is closer to conventional consumer product provision than any other existing method available. Perhaps the biggest difference between homepageNOW and current website provisioning methods is that homepageNOW treats the website as a commodity which is supplied directly to the consumer in a recognizably complete form. In this way, homepageNOW is not a set of tools or an agreement with a website design agency to provide a website based on particular criteria. It is a website obtained and made available as simply as ordering a pizza, choosing toppings and then giving the delivery details.

As with other online shop interfaces on the Internet, the customer selects a product and specifies the personalization details for his or her product within the ordering process (e.g. a suit). Inside the homepageNOW online shop interface, the customer selects a website “straight off the shelf” for his or her chosen topic (e.g. a party) and enters some personal information related to the topic (such as date & location of a party). The order process actually tunes the website to the customer's personal specifications and then publishes it online automatically.

homepageNOW websites include multiple pages of content specific to the topic that was chosen by the customer. Maintaining the website—adding additional content, photos, blog entries—is optional and is done via browser login to the published website.

There is no need for the customer to register a domain, arrange hosting or publish the website on the Internet since these processes are automatically taken care of during the ordering stage. Addressing the processes previously involved in arranging or acquiring a website as listed from BACKGROUND OF THE INVENTION, it is clear that homepageNOW removes the complexities and reduces the required input from a customer to merely choosing a website and filling in an order form—all at the URL of the homepageNOW online shop.

### STATEMENT OF THE OBJECT

homepageNOW brings the power of a contemporary and fully featured website to all people regardless of their background, age, lifestyle or status in the simplest and fastest way currently available.

### BRIEF DESCRIPTION OF THE DRAWINGS

FIG. 1—User Scenarios. This figure shows the different user access modes for the published website and for the homepageNOW online shop interface (homepage owner, invited guests and public visitors).

FIG. 2—Architecture of homepageNOW. This figure shows the storage and backend model of homepageNOW.

FIG. 3—Start Page. This figure shows the starting screen in the homepageNOW interface.

FIG. 4—List Of Homepages In The Chosen Category. This figure illustrates the start of the order process as customers explore products in stock.

FIG. 5—Set Homepage Design. This figure is a screenshot of a product selected from FIG. 4. This is the stage where a product selected by the customer is tailored.

FIG. 6—Enter User And Homepage Data. This figure shows the fields which when completed will be superimposed onto the website to personalize and tailor the product even further.

FIG. 7—Finish Order Process. This figure shows the completion of the order for the homepage.

FIG. 8—Use Of Extras. This figure shows the assignment of extras to the different homepage types.

FIG. 9—Public View Of Photo Album. This figure shows the Photo Album view for public visitors within a homepageNOW party website.

FIG. 10—Inviting Guests To Photo Album. This figure shows the view of the homepage owner within a homepageNOW party website and the ability to send emails to Buddies.

FIG. 11—Guest View Of Photo Album. This figure shows the Photo Album view for invited Buddies within a homepageNOW party website.

FIG. 12—Control Panel. This figure shows where registered homepageNOW users can manage their passwords and personal settings.

### DETAILED DESCRIPTION OF THE INVENTION

Embodiments of the present invention are described herein. It is requested that the following description be considered illustrative and not limiting as in the interests of clarity, not every routine feature is to be mentioned.

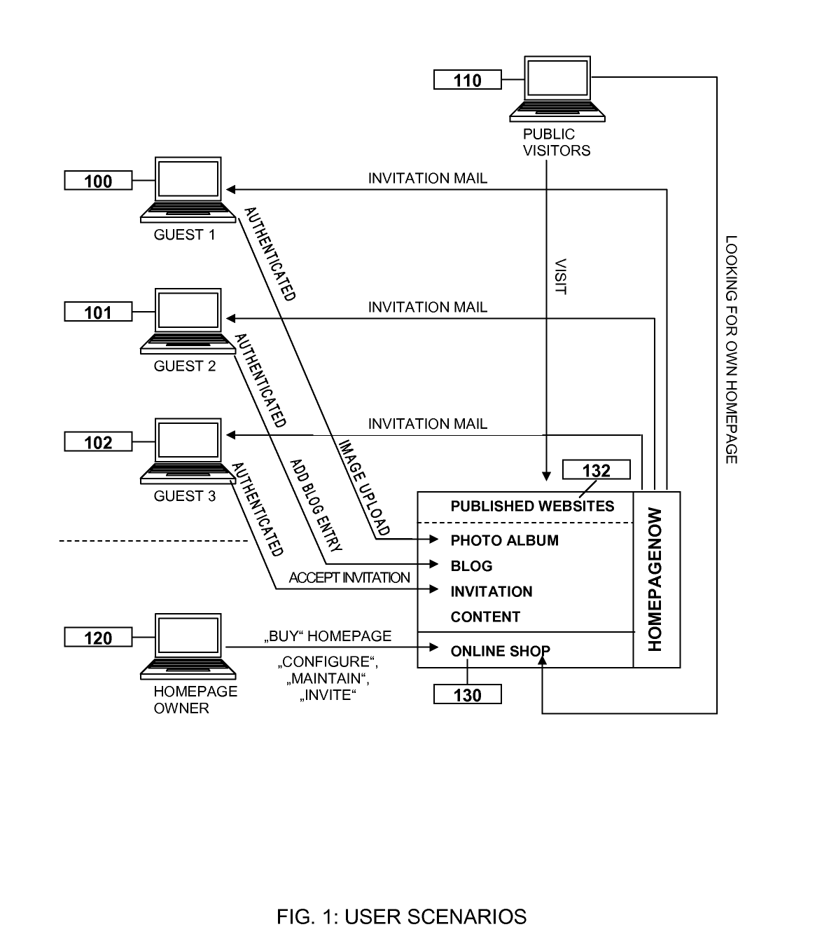

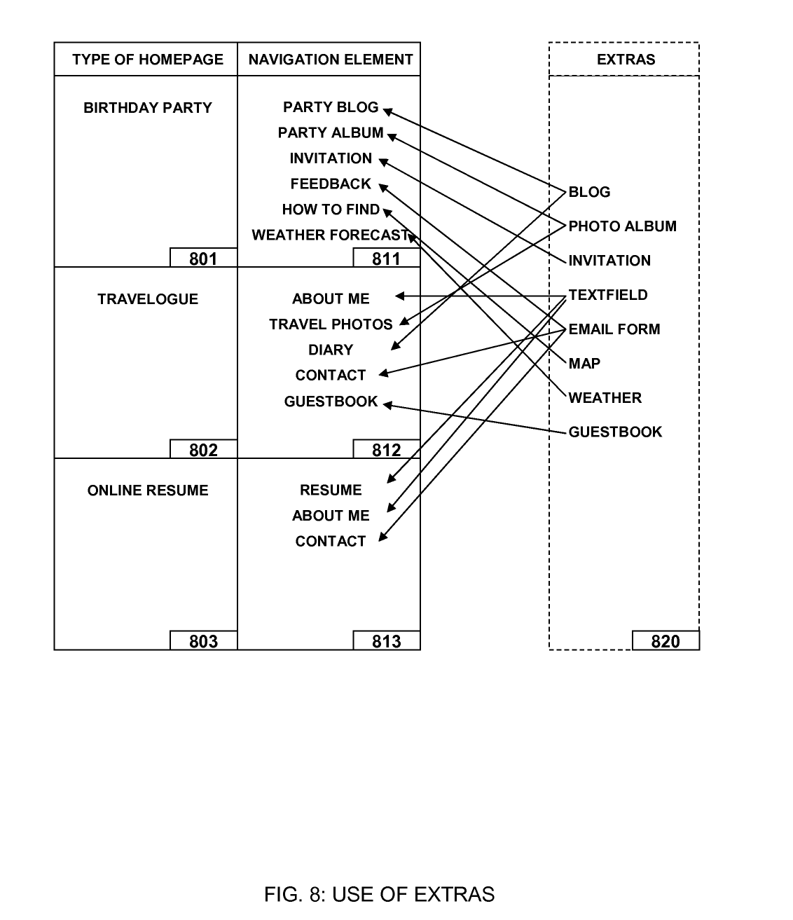

User Scenarios (FIG. 1). homepageNOW is an Internet site that allows consumers to buy and configure fully functional and ready-to-run personal homepages. HomepageNOW also hosts these websites and therefore provides them to the visitors (130). The user chooses from thousands of possible websites in an online shop user interface. He adds one of these homepages to his basket. Afterwards some parameters of the homepage are defined by the user and the homepage is published to the Internet. HomepageNOW then hosts this website until the user chooses to cancel his membership. Hosting means that the HTML of the homepage is made accessible to the public via a web server (132). All dynamic components of the homepage are run by the homepageNOW platform i.e. the blog, photo album, guest management, emails from or to guests and all other dynamic parts (FIG. 8).

homepageNOW is effectively used by three types of groups: Public visitors of homepages (110), guests who are invited to a homepage (100, 101, 102) and homepage owners (120) who are running their personal homepage at homepageNOW.

A Public Visitor (110) visits a homepage because he heard about it or conducted a web search for the name of his friend, for example. Since homepageNOW homepages are real websites with their own domain name and based on standard HTML—not merely a page in a huge community site, all homepageNOW websites can be listed at Google or other search engines in the regular way—just like every other—even professional—website. A Public Visitor (110) can also be interested in creating his own homepage. He is then anytime able to select his own favorite homepage in the online shop (131) of homepageNOW and can sign up as a new user in the final step. Then he would become a homepage owner (120).

Guests (100, 101, and 102) are invited by homepage owners (120) to visit their homepage—but not in anonymous way like the public visitors but in a way that is known to the homepageNOW system. Homepage owners (120) are able to give special access rights to their guests, i.e. the right to upload images to their photo album and the right to add blog entries to their blog. Guests are invited by the homepage owner (120) via an invitation mail which is automatically created by the homepageNOW platform as soon as an owner wants to grant a right to one of his buddies). Different guests can have different rights depending on the definition by the owner.

For example, Guest I (100) is allowed to upload images to the photo album page of the website (132). A visitor to a birthday party who took photos wants to share them with other visitors of the party homepage. To do so he follows a link provided in the invitation email which was sent to him by the system. The link already contains an identification ID that tells the system which user is following this link.

Guest II (102) is allowed to add blog entries. For example a family member who wants to add entries to the family diary while a different family member is the creator and homepage owner (120) of this family homepage.

Guest III (103) conversely, does not have a right to make changes or additions to the website but is invited to a party and is able to accept or decline the invitation. Furthermore he is able to interact with the list of things to bring for the party. The homepage owner is informed about the status of the updated invitation list. Again this guest is following an invitation mail.

The homepage owner (120) buys a homepage via the homepageNOW online shop (131) or chooses from a list of free homepages in the same way. During this process he configures his homepage depending on the type of homepage he wants. This is similar to defining the color and size of clothes when bought in an online clothes shop.

He typically logs in frequently to the published website (132) to maintain his homepage and perform the following maintenance tasks—(a) to add, edit or delete blog entries; (b) to upload or delete photos; (c) to define or update invitation lists; (d) to review or comment on his guestbook; (e) to define a list of guests or to grant or restrict access right to them. In this way he is the administrator of his own homepage. He is running his own social network. All the maintenance tasks are familiar to the majority of Internet users. In fact, these features are very popular and well known from many Web 2.0 portal sites like flickr.com, blogger.com or evite.com. The expertise level needed for buying and maintaining a homepage with homepageNOW is that of a standard user who is able to surf the internet and to use an online shop.

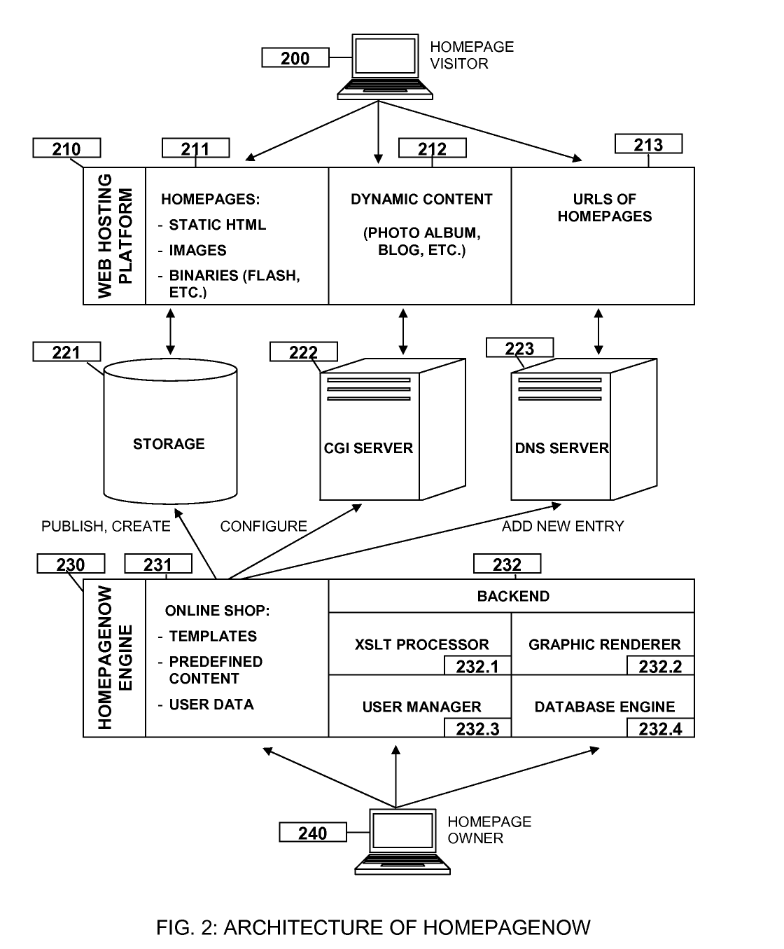

Architecture of homepageNOW (FIG. 2). The homepageNOW platform consists of different hardware and software components. The whole platform is running in a data center which is connected to the Internet. All user contents, all homepages and all functionality for creating and maintaining these homepages and the dynamic parts of these homepages are located on and are run by this platform.

The whole software is written in the programming language C and is our invention. Only for some of the standard server technologies open source standard software is used: RDBMS (Relational Database Management System), web server, DNS (Domain Name Server/System), mail server. The whole architecture is planned in a way to handle extreme loads caused by potentially millions of homepage owners and even more visitors. Therefore a unique backend design was necessary.

The two main parts of the homepageNOW platform are the web hosting platform (210) and the homepageNOW engine (230). While the former provides and serves the published homepages to the Internet, the latter provides the online shop and homepage creation technology to new and existing homepage owners.

The web hosting platform (210) consists of functionality to serve the static homepages (211), to provide the dynamic contents of the homepages (212) and to provide the URLs of these homepages to the Internet user (213). All contents are served by a cluster of web servers, application servers and DNS servers. All static HTML, images and other binary resources—e.g. Flash movies—of the homepage are served by a cluster of web servers. These web servers are connected to a storage backend (221) on which this data is stored.

The dynamic contents of the websites are produced by application server software which is able to identify users and if applicable, to grant permissions to them. The dynamic contents are delivered to the users by a cluster of CGI (Common Gateway Interface) servers (222). The URLs of the homepage and assignment to the different homepages and contents are handled by the DNS sub-system (213) which is connected to a cluster of DNS Servers (223).

If the homepage visitor (200) sends a request for a homepage provided by homepageNOW (e.g. example.party.homepagenow.com) to the Internet, first of all the browser sends a DNS request to the DNS server in charge for the domain “homepage.com” (223). This DNS server knows to assign to 3^{rd} (e.g. party) and 4^{th} (e.g. example) level domains of the request to an existing homepageNOW homepage. The browser is then able to request the start page of the homepage for the matching IP address (Internet Protocol Address) delivered by the DNS.

Identified by the 3^{rd} and 4^{th} level domain, the correct homepage is identified by the web server (211) and the start page is delivered to the browser. The content of the start page was created by the homepageNOW engine and is stored in the storage backend of homepageNOW (221). Depending on the type of homepage chosen by the homepage owner the start page is either dynamic or static. By following the links of the main navigation of the published website the visitor is able to surf through the whole homepage. Static parts are served through the web server (211), dynamic contents (212) by the CGI servers (222).

The other main part of the homepageNOW platform—the homepageNOW engine—consists of an application server providing all functionality to the user via an online shop interface (231) and a backend system (232) helping the online shop to create and maintain its data and to connect to the web hosting platform for publishing the homepage or changing the contents of the published homepage.

The online shop (230) contains templates and pre-defined contents for homepages for the user to choose from. Also the online shop stores all user data allowing an existing user to login to maintain their homepages i.e. their “orders”. The online shop is connected to the backend systems which consist of an XSLT processor (232.1), a graphic renderer (232.2), the user manager (232.3) and a database engine (232.4).

The XSLT processor (232.1) is a backend system that creates a homepage based on a given homepage template written in the programming language XSLT. This is stored in the database, on the pre-written content in the language XML for the given type of homepage also stored in the database and on the user data given by the homepage owner in the “checkout” process. The XSLT processor is triggered by the online shop (231) when the homepage is fully configured, i.e. when the homepage owner is ready to “check out”). The XSLT processor creates the homepage and publishes it to the storage backend (221).

The graphic renderer (232.2) is used to create all graphical and multimedia elements of the homepage which are defined by a given homepage template (which also includes sub-templates for graphical elements like images or Flash movies) and the user data (see above). The graphic renderer is triggered by the XSLT processor which is again triggered by the online shop (see above). The graphical elements are also published to the storage backend (221).

The user manager (232.3) is the sub-system of the backend which manages, i.e. adds to, deletes from and reads from the list of users of homepageNOW. Users can be the following types—(a) anonymous visitors to the online shop who are provided with a cookie maintained by the user manager; (b) guests who were invited by homepage owners and (c) homepage owners.

The user manager manages the guests both when accessing the published homepage which they are invited to and when logging into the online shop. Therefore the user manager is connected to the CGI server (222). If a new homepage is created, the user manager adds a new homepage to the owners list of homepages. In particular, this adds a new entry to the DNS server (223) as a new URL for this homepage. So the user manager is also connected to the DNS server (223).

The database engine (232.4) of the backend is the central database used by all other backend sub-systems or by the online shop to store all kinds of relational data. These are the user lists, the template data, the pre-written contents, the buddy lists of the users as well as several kinds of statistics and maintenance data.

While the web hosting platform is mainly in charge of providing homepages to the public, the homepageNOW engine (230) is the central engine for providing the functionality to create a new homepage for homepage owners. Its direct use is mainly by the homepage owner (240) but it is also connected in many ways with the homepages and other servers and therefore with homepage visitors (200). c2006 Cornel Schnietz

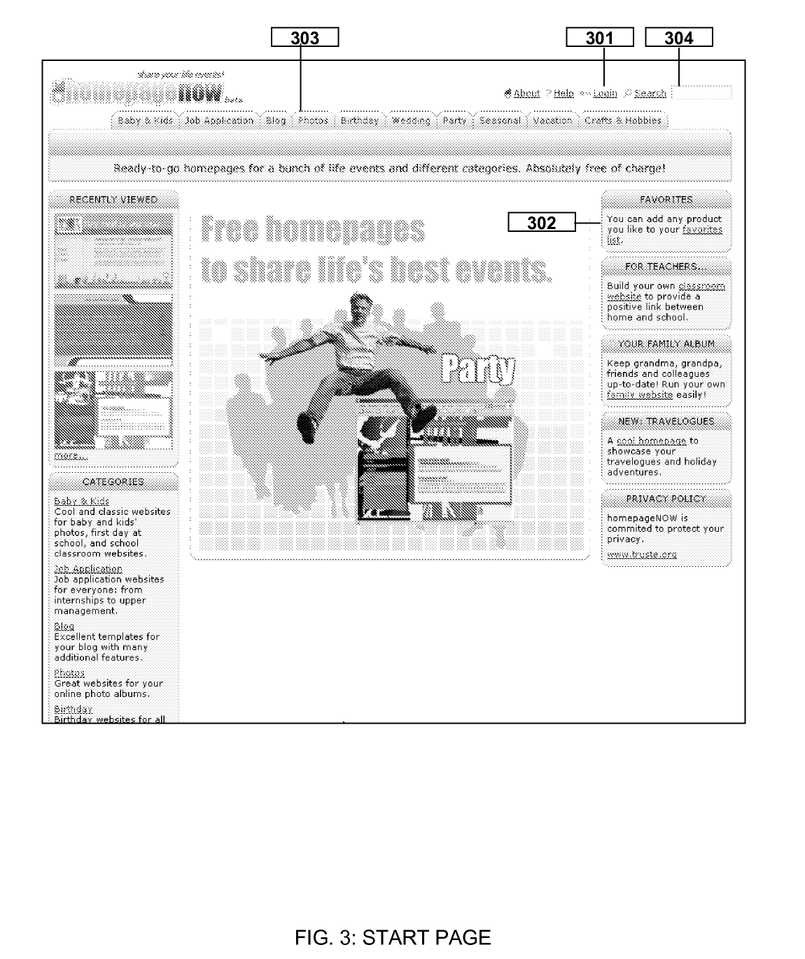

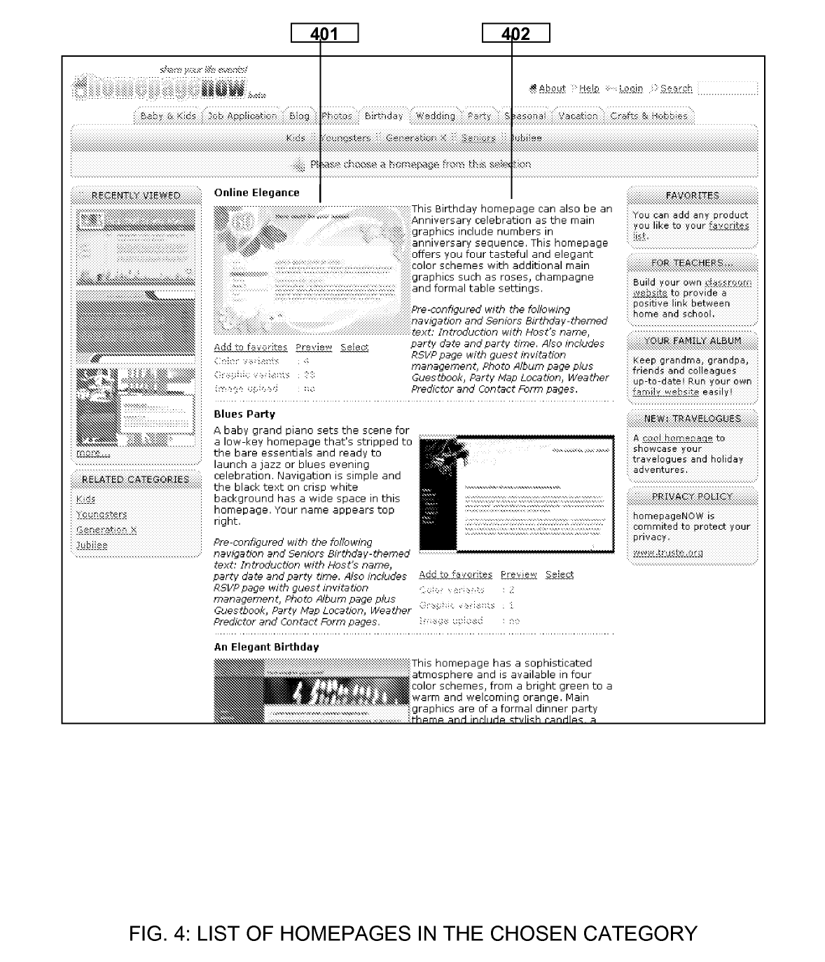

Browsing homepages (FIGS. 3 and 4). The homepageNOW online shop starts with a typical online shop starting page. A main graphic tells the visitor that the products which are sold here are ready-made homepages for all kind of events consumers may have. Next to the main navigation (303), boxes for featuring new types of homepage are provided on the right of the screen. A more detailed description of the different homepage categories can be found on the left of the screen.

A “favorites” box (302) shows the user all homepages he has added to his list of favorites. Existing users are able to log into the personal section of the homepageNOW shop anytime via “login” (301) and. The user is able to search through all homepage offers via the search form (304). Just like in a regular online shop the homepage offers are searched and listed after keyword, name or type. The output is given to the user in the same way as when he is browsing through one of the different categories.

The category list (303) on the top of the page is a well known metaphor for online shops. Here the regular product categories are replaced by different types of homepages. Homepage types refer to events, reasons and purposes for homepages. The homepage types are the following; (a) Baby & Kids, (b) Job Application, (c) Blog, (d) Photos, (e) Birthday, (f) Wedding, (g) Party, (h) Seasonal, (i) Vacation, (j) Crafts & Hobbies.

If the user clicks on one homepage category, a list of sub-categories shows right below the top navigation bar and the shop shows a main graphic for this category explaining the use of homepages of this type. Again this is a common concept for online shops and is familiar to any Internet user. If the user clicks on a given sub-category a list of homepages of this sub-category is shown to the user. Every list item consists of the name of the homepage, a small image (401) and a brief description (402) including information about the number of different colors to choose from and the number of main graphic variants etc.

For every list item the user has the option to add it to his favorites (see above), to see a preview of this homepage or to add it to his selection, i.e. to choose this template to buy or create a homepage with. The preview lets the user surf through a previously created version of this homepage. This homepage preview shows the selected homepage with standard colors and graphics and uses sample values for all user-configured data like name, date etc.

The user can change the category at any time by browsing through the category navigation. Every visited homepage is added to a list of “recently viewed” homepages to help the user revisit homepages. Again this concept is common for online shops.

While dozens of categories and sub-categories are available and couldn't be described here we want to show the functionality of the online shop with the example of a birthday party website. A homepageNOW birthday party website contains various pages that fulfill the consumer's requirements; (a) an Introduction, (b) a Party Information page with the name and the age of the person celebrating the birthday, the party date and party time. Also included is (c) an RSVP page with guest invitation and list of things to bring management, (d) a Party Photos page, (e) a Party Map Location page, (f) Guestbook and (g) a Contact Form page. This basic navigation can be considered as exemplary for all homepageNOW homepages.

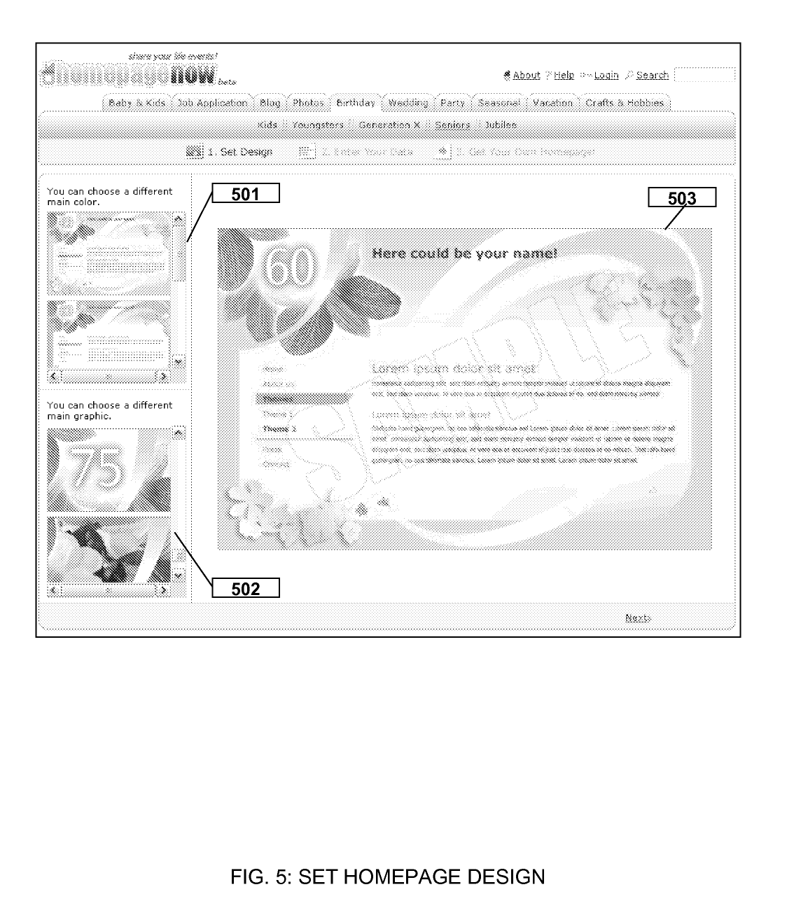

Setting the Homepage Design (FIG. 5). This is the first of three steps which correspond to the check-out process of a regular online shop. Similar to choosing from different colors or sizes of a product in a regular online shop, the homepage color and main graphic can be selected here. HomepageNOW has a limited number of templates to choose from. In order to give every homepage owner the chance to still create a unique homepage, the concept of main colors and main graphics was implemented.

The number of different homepages for a given template is: Number of main colors multiplied by the number of main graphics. Since homepageNOW offers an average of 4 main colors and 15 main graphics per template, literally thousands of different homepages can be created. Even though there will be homepages with an identical template, color and main graphic it's unlikely that a given homepage owner is invited to one which looks identical to his homepage and less likely still that the names and personal information will be duplicated.

The main part of the screen in this step shows a preview of the selected homepage in its present configuration (503). A list of thumbnail graphics showing the template in different color variants (501) and a list of different main graphics (502) are shown to the user. Clicking on either of the templates updates the preview (503) with the selected color or main graphic. The user confirms this step by clicking “next”.

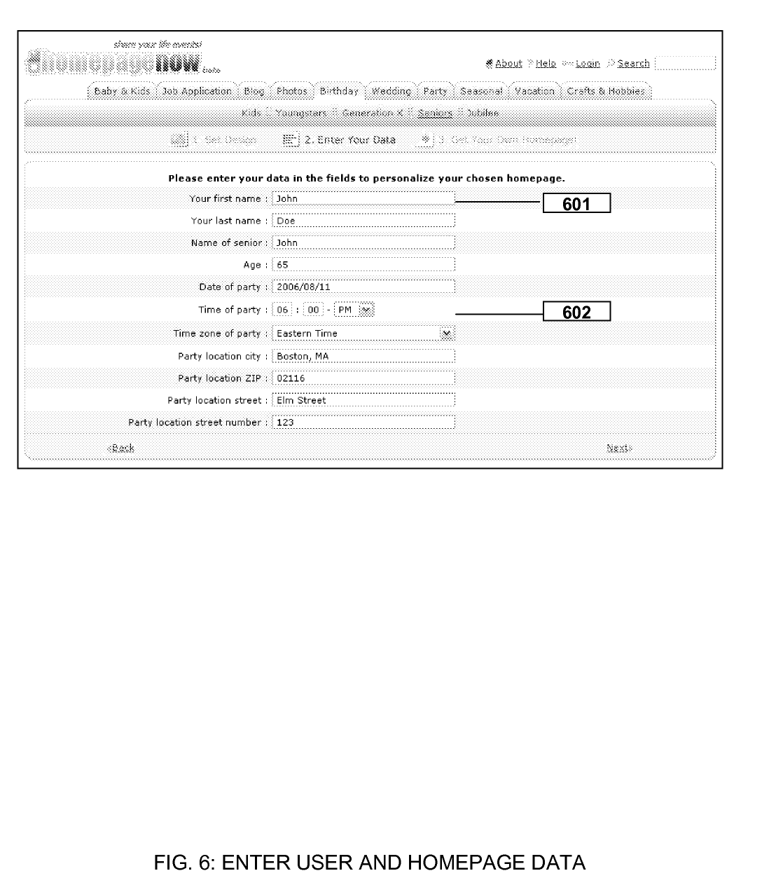

Entering the User Data (FIG. 6). The second step of the check-out process is similar to entering your billing information—e.g. your name and credit card number—and your shipping address as a last step when ordering products in a regular online shop. Here the homepage owner is asked for his personal data—first name, last name (601) and—depending on the chosen type of homepage—for some details about the homepages' subject. In the case of a birthday party homepage, homepageNOW asks for the location (i.e. street address and city) and exact date and time of the event (602).

This information is used in several ways by homepageNOW. The personal data is used to create the information page about the homepage owner. The street address is verified via an Internet address server and in case of an ambiguous address entry, several alternative addresses are given to the user. After he has chosen the correct one, that address is used to create a graphical map of the location which—together with address information—makes the “How to find us” page. Furthermore the address is used for a weather page which shows dynamically the actual weather forecast for the party location. The exact time is used for the invitation page and in addition, for a countdown extra which counts down the days, hours and seconds until the party begins.

In this way the user is asked for as little information as is absolutely necessary to set up the party homepage and the information is used in multiple ways to create a fully functional homepage.

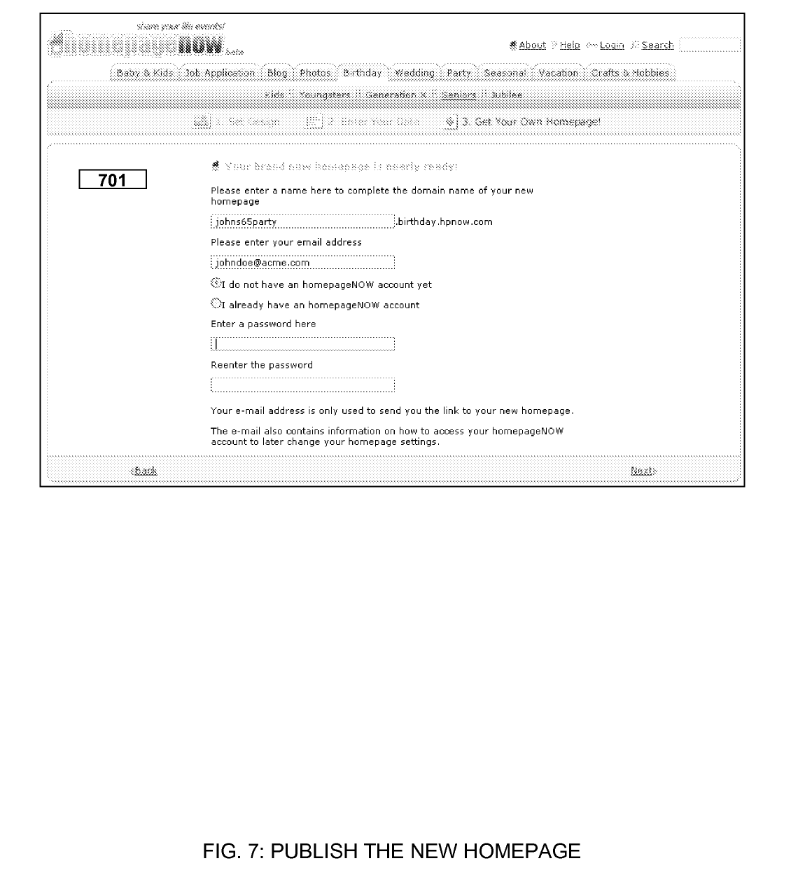

The published homepage (FIG. 7 and FIG. 8). The third and final step of acquiring the homepage is entering the desired domain name (701), the email address and—for new users—a password. Again this is similar to an online shop. Here the last step is very often to create an account for this online shop which gives returning users the option of logging in and buying things without entering their user information and preferences once again.

A verification mail is sent to the users email address to authenticate it. The email contains a link back to homepageNOW. If the user follows that link his homepage is published and the user is redirected to his homepage.

In these three simple steps the homepage is online. For the average user this process will take less than a minute. By far the most time will be used to browse through the shop interface and look through all the different types of homepages, which is of course a pleasant thing to do.

The birthday party homepage in our example will consist of the following pages: (a) Home—starting page with brief information about the event and the host of the event. The personal data is used here. The homepage may also show a party countdown and again, the date and time information is employed; (b) Party Blog—a blog which can be used by the host as a diary. The blog contents will be created before and after the party as a diary and the blog starts empty; (c) Photo Album—a photo album where party pictures can be uploaded by the homepage owner or by invited guests; (d) Invitation—the invitation page where people are able to accept or decline the invitation or define things to bring. The date and time information is used here also to show a calendar to the visitor. The homepage owner can add people from his buddy list to this invitation list. He has a status list of his guests here too; (e) Guestbook—a web guestbook which lets visitors leave an entry before or after the party; (f) How To Find Us—a page with a map and the address information for visitors. The address information from the customer is used here; (g) Weather—a page showing the actual weather and the forecast for the party location at the time of the party. Again the address information is used here; (h) Contact—an email form which lets visitors send an email to the homepage owner. The email address provided is used by the homepageNOW server. The email address is not visible to the visitor.

Other types of homepages will have different pages and a different use of the extras available in the system. HomepageNOW is designed in a way that new categories, sub-categories, homepages, templates and extras can be added any time. So the list of possible features and pages will even increase in the future.

FIG. 8 shows the list of extras available in homepageNOW (820) and their use as pages (811, 812, 813) in the different types (801, 802, 803) of homepages of homepageNOW. It would go beyond the scope of this document to describe all the extras of homepageNOW in detail. Furthermore since the details of each extra are not essential for the claims of this invention it should be sufficient to describe one exemplary extra the photo album.

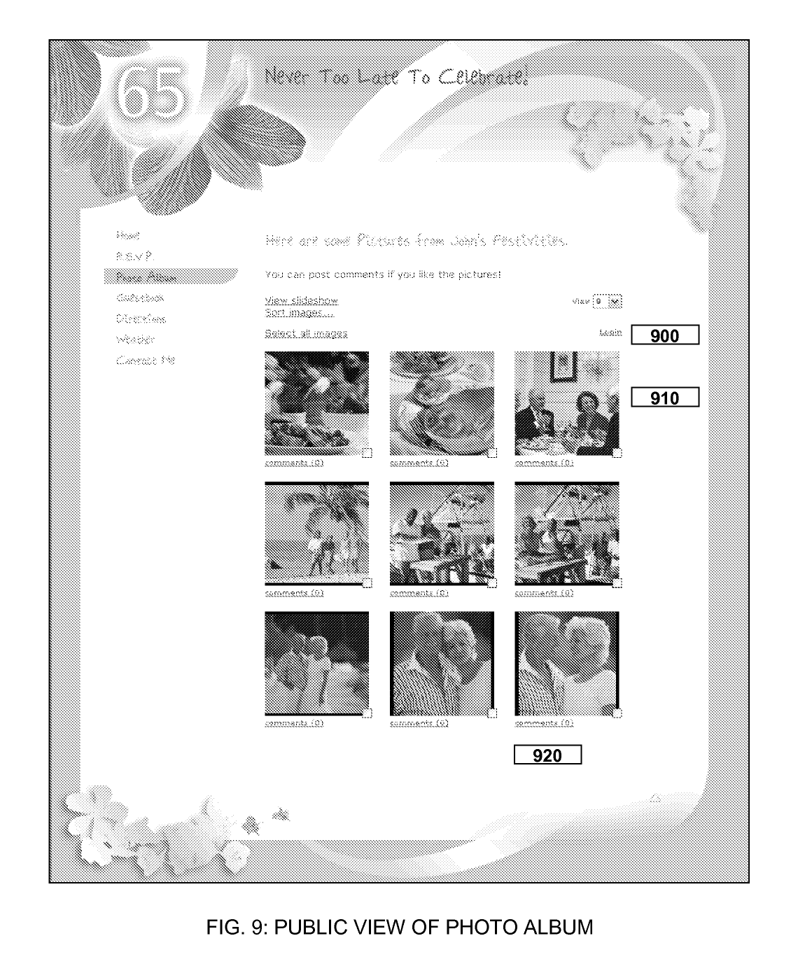

Public view of the photo album (FIG. 9). While the creation process of the homepage uses the online shop metaphor, the maintenance of the website—especially the continuous addition of contents to the website—should be considered similar to the way a big portal site operates.

We can use many well known photo portals as examples. The process of uploading images via a web browser to a photo service, of viewing online slideshows and of sharing photos with friends via a photo website is already pretty common on the Internet and is used by tens of millions of Internet users every day. Well known photo portals are flickr.com, Yahoo photo and MSN photos. homepageNOW is presenting images in a very similar way but they are integrated within the personal homepage of the homepage owner. So consumers are no longer forced to organize and share their images in a photo portal but can do so in their own homepage. This is especially interesting for more personal events like a wedding.

The visitor to the homepage follows a link in the homepage navigation “Photo Album” to reach the photo album extra. The photo album starts with a view on the first 9 images of the photo album as small thumbnail images (910). A link (920) under each of these thumbnail images leads to a larger view of this image and to an HTML form which allows comments about this image to be left. Every visitor is able to leave a comment but the owner can delete a comment at anytime. Images can be sorted by the visitor or selected by him to be downloaded or sent to an online printing service.

A link “login” (900) is provided. This link can be used by an invited guest or by the homepage owner to log into his photo album.

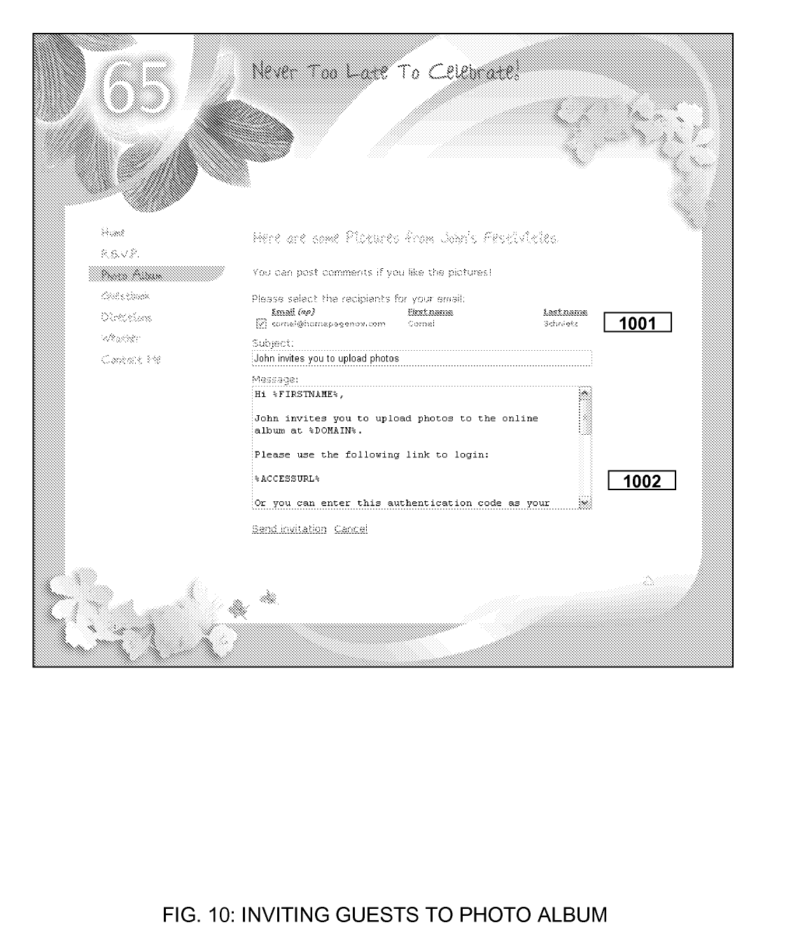

Inviting guests to the photo album (FIG. 10). After the homepage owner logs into the photo album he is provided with all the functionality required to maintain the photo album. While guests are also able to delete and rotate images uploaded by them, only the owner is able to invite guests to his photo album. To do so, he follows a link “Invite guests to photo album” in the top navigation of the photo album extra. Afterwards he can invite guests from his buddy list (1001) to the photo album. A pre-written notification email (1002) can be edited by the homepage owner or can be sent directly. The email is then sent to all guests selected in the buddy list. The email contains a link which leads directly to the photo album of this homepage. So an invited guest neither needs to surf through the homepage to find the photo album nor needs to log into the photo album to for example, upload images.

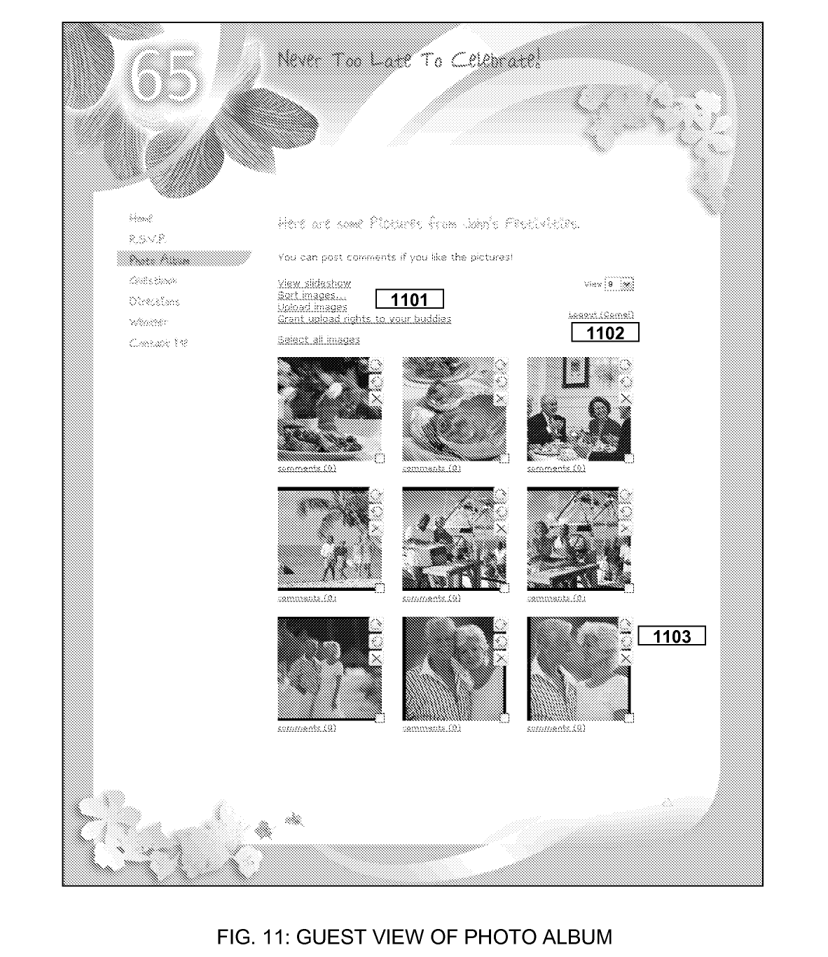

View of an invited guest (FIG. 11). An invited guest can log into the photo album either via the login link or via a direct link in the invitation email. In contrast to the public view described above, invited guests have several additional functionalities. They are able to upload images (1101) and to rotate or delete images (1103). Additionally they have the entire functionality public viewers have. Invited guests are not able to delete or rotate images uploaded by anyone other than themselves.

The upload is done completely via the web browser. For more convenience and better performance an ActiveX control is used here in their Microsoft Internet Explorer and a Java Applet for Mozilla. These in-browser-applications allow owner and guests to add new photos to their homepage as easily as with a Microsoft Windows application. A “logout” link is provided to log out and return to the view of the public viewer.

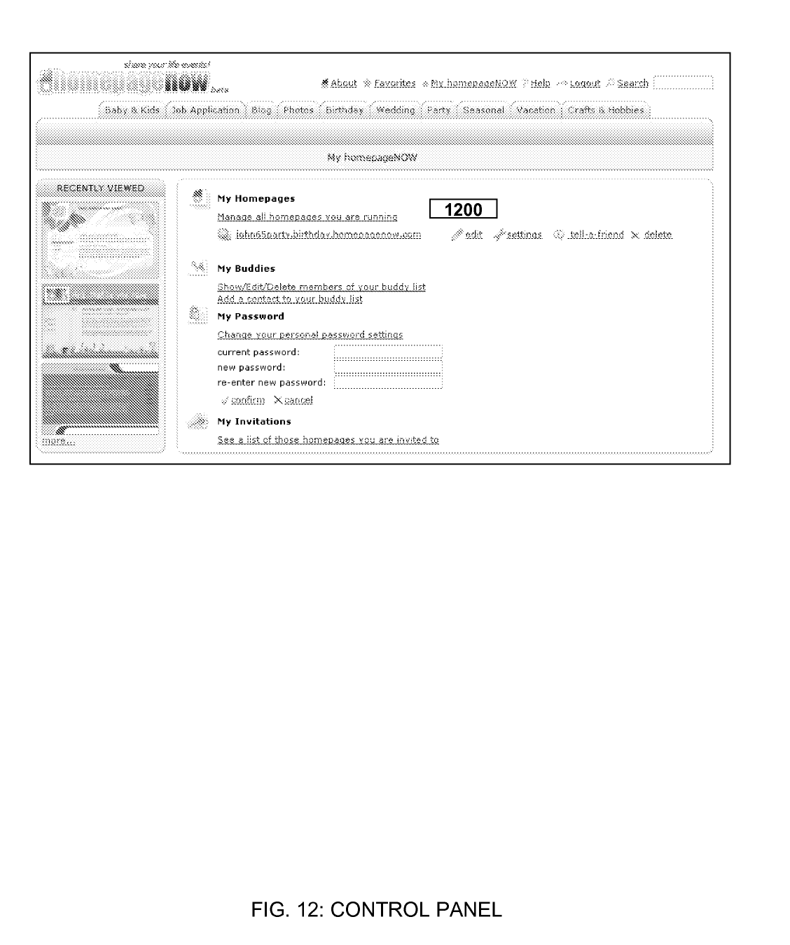

The control panel “My homepageNOW” (FIG. 12). Every homepage owner has created a homepageNOW account which allows him to log into the control panel of homepageNOW at anytime. Also invited guests have the possibility to create a homepageNOW account. Then they won't need to use the link provided in the invitation email anymore but can log into any extra feature such as a photo album for example that they are invited to with their homepageNOW username and password. This is especially important for people who are invited to a number of extra features or even to several extras in homepages belonging to different owners. Without a homepageNOW account they need to handle different passwords and links for every extra. In contrast, a homepageNOW account allows them to log into every extra with the same credentials.

Additionally the “My homepageNOW” control panel shows a list of all homepages somebody is invited to with the possibility to log into any of them without a new authentication. From the homepageNOW system's perspective, two invited guests are the same if they have the same email address. So if two different homepage owners have created two different buddies and invited them, these two buddies are considered the same if they have the same email address. The corresponding homepageNOW account is then authenticated to log into both websites where the buddies were invited to.

After logging into the control panel “My homepageNOW”, the user sees a list of all homepages he is running at homepageNOW (1200). There he is able to edit a homepage, i.e. to restart the three step process. Furthermore, he is able to delete a homepage or to send a notification or general invitation to his homepage to a list of friends via the “tell-a-friend” link.

The homepage owner has access to his buddy list which is a list of all buddies he created by inviting people to his party or photo album. Here he can add, delete or edit buddies in his list. In the control panel the user is also able to change his account data such as passwords for example. Finally a list of all invitations to other websites is accessible in “My homepageNOW”.

### Definitions

Internet: The worldwide, publicly accessible system of interconnected computer networks that transmit data by packet switching using the standard Internet Protocol (IP). It consists of millions of smaller domestic, academic, business and government networks, which together carry various information and services, such as electronic mail, online chat, file transfer, and the interlinked Web pages and other documents of the World Wide Web. (Source Wikipedia Encyclopedia)

Homepage: The website of a group, company, or organization. (Source Wikipedia Encyclopedia)

Personal homepage: A personal homepage is a World Wide Web site belonging to one person. It can be about that person or about something he or she is interested in. A personal homepage may be as simple as a single page or may be as elaborate as an online database. The content of personal homepages varies and can, depending on the hosting server, contain anything that any other websites do. Many also contain short biographies, résumés, and blogs. (Source Wikipedia Encyclopedia)

Website: A collection of Web pages, typically common to a particular domain name or subdomain on the World Wide Web on the Internet. (Source Wikipedia Encyclopedia)

Online Shop: An online shop, Internet shop, webshop or online store evokes the physical analogy of buying products or services at a bricks-and-mortar retailer or in a shopping mall. It is an electronic commerce application used for B2B or B2C. (Source Wikipedia Encyclopedia)

Interface: The connection between a user and a machine. (Source Wikipedia Dictionary)

Blog: A weblog, which is usually shortened to blog, is a type of website where entries are made (such as in a journal or diary), displayed in a reverse chronological order. Blogs often offer commentary or news on a particular subject, such as food, politics, or local news; some function as more personal online diaries. (Source Wikipedia Encyclopedia)

Browser login: Browser login is a feature of homepageNOW that enables selected visitors to the website to interact with the site by uploading graphical content such as photographs and to add text content such as a blog entry to the relevant pages by entering a password into a small field space set within the page. Browser login therefore permits remote contribution to the website using any browser e.g. Internet Explorer and from any location that has Internet access. It transforms previously static pages into dynamic private community pages thus enabling social networking.

Social network: A social network is a social structure made of nodes which are generally individuals or organizations. It indicates the ways in which they are connected through various social familiarities ranging from casual acquaintance to close familial bonds. (Source Wikipedia Encyclopedia). In addition, this term relates directly to the invention as users of the invention have the power to assign access rights to members of a social network they define. The invention permits the creation of private social networks—differentiated from public social networks which anyone can join and which currently account for the majority of social networks on the Internet.

Multi-author: Multi-author is used in the context of the invention as a means for members of the user's social network—who have been assigned specific access rights—to log into the website and add content of a written or graphical nature, i.e. adding an entry to a blog or uploading a photograph to a photo album within the website. Multi-authoring is a foundation stone of social networking.

Access rights: Most modern file systems have methods of administering permissions or access rights to specific users and groups of users. These systems control the ability of the users affected to view or make changes to the contents of the file system. (Source Wikipedia Encyclopedia). In addition, the file system referred to in this instance is a website and the permissions that are administered are passwords distributed by email to guests defined by the user of homepageNOW. Access rights are also called “authoring rights”.

Pre-written web page content: The information within a website is called “content”. This may have varying forms, such as graphics, images, sound files, video, animation, hyperlinks, numerals and of course text. homepageNOW websites contain pre-written text content which means that the customer has much less work to do. homepageNOW has categories of events, uses and purposes in lists that the customer chooses from, e.g. a birthday party website. Sections of this birthday party website have already been written by the homepageNOW project team based on research of contemporary birthday websites on the Internet. In this way, a composite of the anticipated content is already provided as part of the website—it can even be said that the written content is part of the selected website's design.

Straight off the shelf: homepageNOW provides a selection of pre-configured and to an extent, pre-written websites that are already designed and merely awaiting minor adaptations and the transposition of customer information to individualize and publish them during the order process. We therefore use the term “off the shelf” to indicate the state of readiness of our websites. For example, a suit when selected at a high street store is said to be available “off the shelf” even though the garment may be available in different colors and may require subtle tailoring to match the individual's specification. What we imply, is that manufacture to order, to brief or to consultation is not required. Rather, the website already exists in its pre-individualized state and is activated, customized and published during the order process itself.

Web 2.0: As used by its proponents, the phrase refers to one or more of the following: The transition of websites from isolated information silos to sources of content and functionality, thus becoming computing platforms serving web applications to end users. A social phenomenon referring to an approach to creating and distributing Web content itself, characterized by open communication, decentralization of authority, freedom to share and re-use, and “the market as a conversation”. A more organized and categorized content, with far more developed deep-linking web architecture. The resurgence of excitement around the possibilities of innovative web applications and services that gained a lot of momentum around mid 2005. (Source Wikipedia Encyclopedia)

### INDUSTRIAL APPLICABILITY

The invention makes it possible for any level of user who is familiar with the concept of a homepage/personal homepage/website and has access to the Internet to order and maintain a contemporary and fully-featured social networking homepage/personal homepage/website.

The invention makes it possible for people with no knowledge of the processes involved—previous to this invention—of obtaining a website, to enjoy and benefit from the ability of the Internet and its multi-authoring to create and manage online communities, find and nurture friendships, interact with like-minded people and organize a wide variety of events.

The invention provides not only a Web 2.0 interface and idea (an online shop interface with configuration, tailoring and publishing executed in real time during user interaction) but also a Web 2.0 product—a fully functional social networking website with pre-written content—in the simplest and most direct way currently available—in: keeping with the overall ideals, dynamics and guiding principles behind one of the universal open communication missions of the Web 2.0 paradigm.

1. I claim that “an online shop interface providing fully featured websites individualized and published during a simple order process” is my invention.

2. I acknowledge that the use of the word “homepage” including its presence in the name of the invention and during the order process, relates to “websites”, “homepages” and “personal homepages”—as stated in DEFINITIONS.

3. I acknowledge that my invention includes the provision of websites from an online shop and that the online shop contains an order process which is designed to individualize and then publish pre-configured websites without the customer using on or offline software.

4. I acknowledge that my invention includes the ability for customers to choose a website from a pre-populated list in pre-defined categories which are geared to contemporary social, consumer and professional uses for websites.

5. I acknowledge that the order process includes the collection of customer information that is superimposed onto the pre-configured website to transform a stock website into an individualized website containing details unique to each customer, for example—name, birthday, address and occasion, location and event.

6. I acknowledge that my invention includes the provision of pre-written web page content text that anticipates the purpose the website is intended for when selected from the pre-populated list to save customers time and to streamline the process of acquiring a website.

7. I acknowledge that my invention reserves web space and publishes each website automatically during the order process without the customer having to organize domain registration or purchase, lease or arrange web space.

8. I acknowledge that my invention includes the ability for customers to remotely maintain their websites—after the order process has automatically published them on the Internet—via browser-based login: VIZ: My invention allows users to update photograph galleries and weblogs without using any content management or website creation and editing software of either on or offline designation.

9. I acknowledge that my invention permits the creation of social networking connections using a multi-author photograph album, a multi-author blog and an online RSVP organizational feature. These features—termed “extras” in Detailed Description of the Invention—are all accessed by browser-based login rights that may be distributed by the customer after the website has been ordered and therefore published on the Internet.

10. I acknowledge that my invention requires no software to be purchased, leased or downloaded to specifically maintain the website other than generic computer software such as a platform, e.g. Microsoft Windows and a browser, e.g. Microsoft Internet Explorer and Internet connection applications.

11. I acknowledge that my invention is a “website shop” and is comparable with other online purchasing outlets in the processes of selecting a product and tailoring the product to a customer's specifications via an order form.

12. I acknowledge that my invention uses the following Process to provide any level of customer with a website; (a) visit the homepageNOW shop interface on the Internet; (b) browse through the available website products for specific categories; (c) select a website; (d) choose from available color schemes and main graphics for the website; (e) fill in the required form fields with personal information (related to website topic); (f) click on “finish” to submit the order and after confirmation the website is made available.
